(19) United States
(12) Patent Application Publication
(10) Pub. No.: US 2007/0260525 A1
(43) Pub. Date: Nov. 8, 2007

(54) Telephone Number Marketplace

(76) Inventor: Dion M. Bregman, Palo Alto, CA (US)

Correspondence Address: Dion M. Bregman, 2360 Carmel Dr., Palo Alto, CA, 94303, US

(21) Appl. No.: 11/381,736

(22) Filed: May 4, 2006

(51) Int. Cl. G06Q 30/00

(52) U.S. Cl. 705/26

(57) ABSTRACT

Initially, a marketplace server receives an offer for sale of a telephone number from a seller. The offer for sale, including the telephone number for sale and the sales price, is stored in a database on the marketplace server. At any time thereafter, the server may receive a request from a buyer to buy the telephone number from the seller. A sale of the telephone number is then facilitated from the seller to the buyer, such as by searching a database of multiple telephone numbers for the telephone number, locating the telephone number, and contracting with the buyer to purchase the telephone number. Transfer of the telephone number to the buyer is subsequently effected and the buyer informed of the transfer.

### BACKGROUND OF THE INVENTION

1. Field of the Invention

The present invention relates generally to electronic commerce, and in particular, to a centralized exchange or marketplace for buying and selling telephone numbers.

2. Description of Related Art

Despite there being over a billion telephone numbers worldwide, a telephone caller can easily contact a desired party by dialing the desired party's telephone number. Currently, within the United States, local telephone calls require seven digits, such as 212-4567, while long distance calls require dialing a “1” followed by a three digit area code (or toll free code) before the same seven digits.

Subscribers to a public telephone system are generally assigned one telephone number per telephone line. Particular telephone numbers may be valuable to subscribers for a number of reasons, including being easy to remember, having some goodwill, trademark, brand or vanity significance. For example, other subscribers may associate a particular telephone number with a particular subscriber. Furthermore, a subscriber may have gone to great expense listing a particular telephone number on stationary, business cards, advertisements, or the like. Still further, many countries include sub-sets of the alphabet on numbers 2 through 9 on telephone keypads. These numbers are often used to easily identify a subscriber by spelling a word on the telephone keypad. An example of such a telephone number for a toll free commercial entity is “1-800-HOLIDAY” (also known as “1-800-465-4329”) for HOLIDAY INN hotels reservations and information. In other words, the above described telephone numbers have goodwill value that telephone subscribers would like to maintain.

Consequently, subscribers would suffer a tremendous loss if they could not transfer their particular telephone number to a new location, such as when moving to a different geographical area. Accordingly, the telecommunications industry started allowing limited telephone number portability. Indeed, the U.S. Telecommunications Act of 1996 mandates local telephone number portability, where possible.

The process for applying numbers to subscribers is currently ad hoc. Generally, a subscriber will be assigned a number randomly, or will be able to select a number from a finite list of numbers, depending on the telecommunication provider. Subscribers are not generally given a free choice of available numbers.

Further, telephone number choices are typically limited to numbers that exist within the exchange of the service provider, and then further limited to the telephone numbers that are numbers within that exchange. However, despite the advantages of number portability, where subscribers are free to keep their existing number, subscribers generally cannot initially select a number that has some intrinsic value to the subscriber.

In light of the above, a system and method for easily buying, selling and transferring telephone numbers would be highly desirable.

### BRIEF SUMMARY OF THE INVENTION

According to the invention there is provided a computer implemented method for facilitating the sale of a telephone number from a seller to a buyer over a network. Initially, the marketplace server receives an offer for sale of a telephone number from a seller. The offer for sale is then stored in a database on the marketplace server. The offer for sale typically will include the telephone number for sale and details about the seller, such as the sellers contact details and the sales price. The server then receives a request from a buyer to buy the telephone number from the seller. A sale of the telephone number is then facilitated from the seller to the buyer, such as by searching a database of multiple telephone numbers for the telephone number, locating the telephone number, and contracting with the buyer to purchase the telephone number. Such contracting may include offering the telephone number to the buyer, receiving an acceptance of offer for sale from the buyer, and obtaining compensation for the telephone number from the buyer, such as by debiting the buyers financial or bank account. Transfer of the telephone number to the buyer is then effected.

In an alternative embodiment, the a search request containing a string of characters may be received from the buyer. The string of characters may include numbers, letters, words, phrases, terms, or any combination of the aforementioned. A database of telephone numbers may then be searched for one or more telephone numbers that correspond to the string of characters. At least one telephone number that corresponds to the string of characters is then located and transmitted to the buyer.

According to another embodiment of the invention, there is provided a system for facilitating the sale of telephone numbers. The system includes a network, at least one buyer client computer, and at least one seller client computer. The buyer client computer is operated by a buyer and is coupled to the network. Similarly, the seller client computer is operated by a seller and is coupled to the network. A marketplace server is also coupled to the network. The marketplace server includes a processor, communication circuitry, and a memory, all coupled to a bus. The communication circuitry is configured for communicating with the network, buyer client computer and seller client computer. The memory includes an operating system, communication procedures, a database, and search procedures. The communication procedures are configured to receive an offer for sale of a telephone number from the seller, and a request from a buyer to buy a desired telephone number. The database contains multiple telephone numbers for sale and seller details for each of the multiple telephone numbers. The search procedures are configured to search the database for the desired telephone number. The memory also preferably contains instructions for facilitating a sale of the desired telephone number from the seller to the buyer, and instructions for transferring the desired telephone number from the seller to the buyer.

According to yet another embodiment of the invention there is provided a computer program product for facilitating the sale of telephone numbers. The computer program product comprising computer readable storage and a computer program stored therein. The computer program includes instructions for performing the method(s) of the invention.

Consequently, the invention provides a mechanism for buying, selling, trading, and auctioning telephone numbers. This substantially increases the present constrains on number portability, while giving subscribes a free choice of their telephone numbers.

### BRIEF DESCRIPTION OF THE DRAWINGS

For a better understanding of the nature and objects of the invention, reference should be made to the following detailed description, taken in conjunction with the accompanying drawings, in which:

FIG. 1 is a schematic diagram of a telephone number marketplace architecture, according to an embodiment of the invention;

FIGS. 2 is a block diagram of the marketplace server shown in FIG. 1;

FIGS. 3A through 3C are flow charts for a method for buying, selling or trading telephone numbers, according to an embodiment of the invention; and

FIGS. 4A and 4B are screenshots of a graphical user interface of the telephone number marketplace system shown in FIG. 1.

Like reference numerals refer to corresponding parts throughout the several views of the drawings.

### DETAILED DESCRIPTION OF THE INVENTION

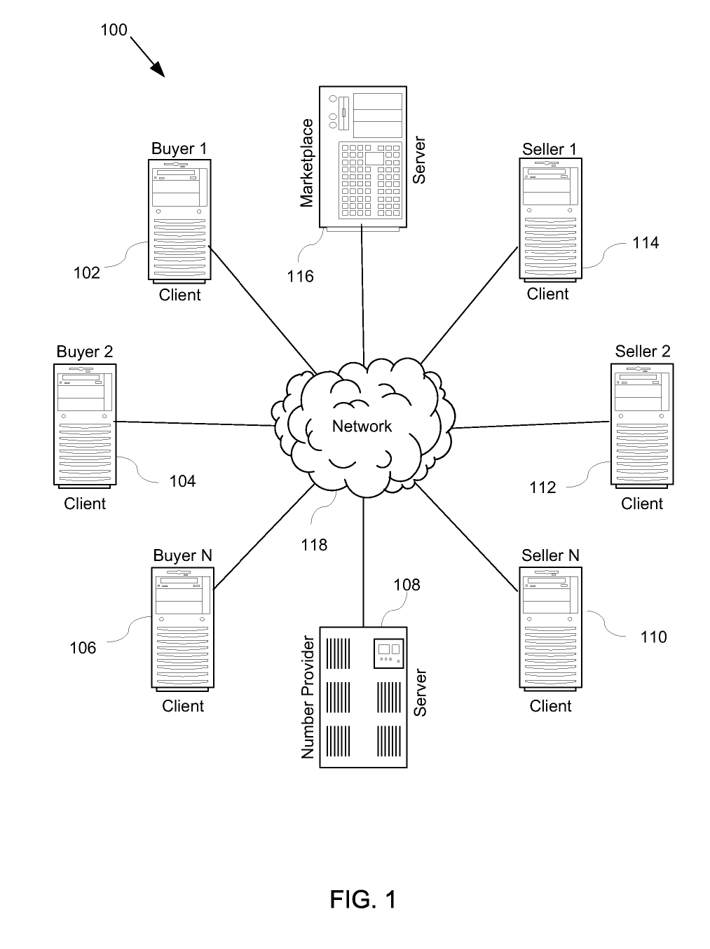

FIG. 1 is schematic of a telephone number marketplace system 100. The marketplace system 100 facilitates the purchase, sale, and trade of telephone numbers. The telephone numbers may include land-line telephone numbers, mobile/cellular telephone numbers, Voice Over Internet Protocol (VOIP) telephone numbers, or the like. Indeed, in an alternative embodiment, any identification string of characters, such as of numbers, letters, term(s), phrase(s), and any combination of the aforementioned may be traded, such as Internet Protocol (IP) addresses, or the like.

The marketplace system 100 preferably includes multiple client computers or clients and at least one server coupled to a network 118. The network 118 comprises a series of points or nodes interconnected by communication paths. The network may interconnect with other networks, may contain subnetworks, and may be characterized in terms of its spatial distance as either a local area network (LAN), a metropolitan area network (MAN), a wide area network (WAN), or a global network, such as the Internet. However, in the preferred embodiment, the network 118 is the Internet. The network may further be characterized by the type of data transmission technology used, such as a TCP/IP (Transmission Control Protocol/Internet Protocol) network, an SNA (Systems Network Architecture) network, or an ATM (Asynchronous Transfer Mode) network. Additionally, the network may be characterized by whether it carries voice, data, or both; by who can use the network (public or private); or by the usual nature of its connections (e.g. dial-up, dedicated, switched, non switched, or virtual connections). The clients and servers connect to the network via communication links, such as coaxial cable, copper wire, optical fiber, radio waves, microwave, satellite links, or other wired or wireless links.

The client computers are operated by a number of telephone number buyers and/or telephone number sellers. The telephone number buyers use buyer client computers 102, 104, and 106, while the telephone number sellers use seller client computers 110, 112, and 114. The client computers may be any suitable computers that are capable of connecting to the network 118, such as personal computers, laptop computers, cellular phones, pagers, laptop computers, Personal Digital Assistants (PDAs), or the like. Each client computer 102, 104, 106, 110, 112, and 114 preferably includes a processor, memory, communication circuitry, user interface devices, etc. Each client also preferably includes a network access application, such as an Internet Browser like MOZILLA, OPERA, or INTERNET EXPLORER, for accessing and browsing the network 118.

The marketplace system 100 also preferably includes a marketplace server 116 and a number provider server 108, both coupled to the network 118. The marketplace server 116 is administered by a marketplace operator. The marketplace server 116 facilitates the purchase, sale and/or trade between the buyers and the sellers, or between the marketplace operator and the buyers. The number provider server 108 is preferably a server maintained and operated by one or more telephone service providers. Alternatively, the number provider server 108 may be separate servers, each operated by a distinct telephone service provider. In yet another embodiment, the number provider server 108 may be operated by a government agency, such as the U.S. Federal Communications Commission (FCC). It should, however, be appreciated to those skilled in the art that the number provider server 108 is merely a preferred component of the system 100 and is in no way a necessary component of the system 100.

Although not shown, the network 118 may also be coupled to other clients and servers, such as banks or other financial institutions for conducting electronic commerce.

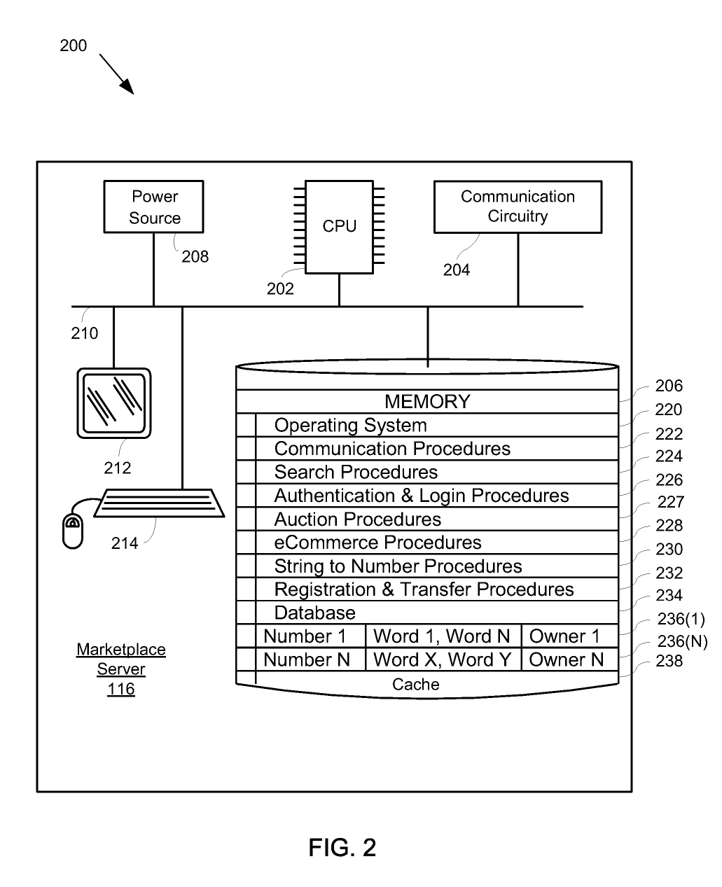

FIG. 2 is a block diagram of the marketplace server 116 shown in FIG. 1. The marketplace server 116 preferably includes: at least one data processor or central processing unit (CPU) 202; memory 206; communication circuitry 204 for communicating with the network 118, buyer clients 102, 104 and 106, seller clients 110, 112 and 114, and the number provider server 108 (all of FIG. 1); a power source 208 configured to be self contained or coupled to a source of power; and at least one bus 210 that interconnects the aforementioned components. The marketplace server 116 may also optionally include one or more user interface devices, such as a monitor 212 and a keyboard and mouse 214 also coupled to the bus 210. The communications circuitry preferably includes one or more Network Interface Cards (NICs) for communicating with the network 118 using one or more communication protocols, such TCP/IP, ATM, Ethernet, or the like.

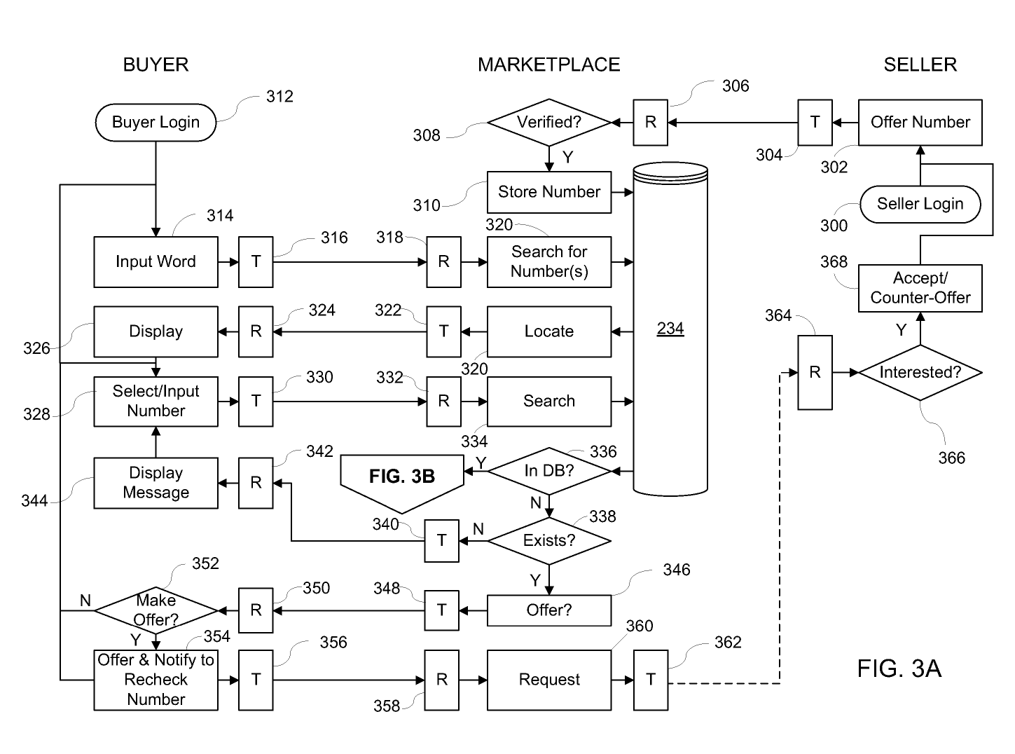

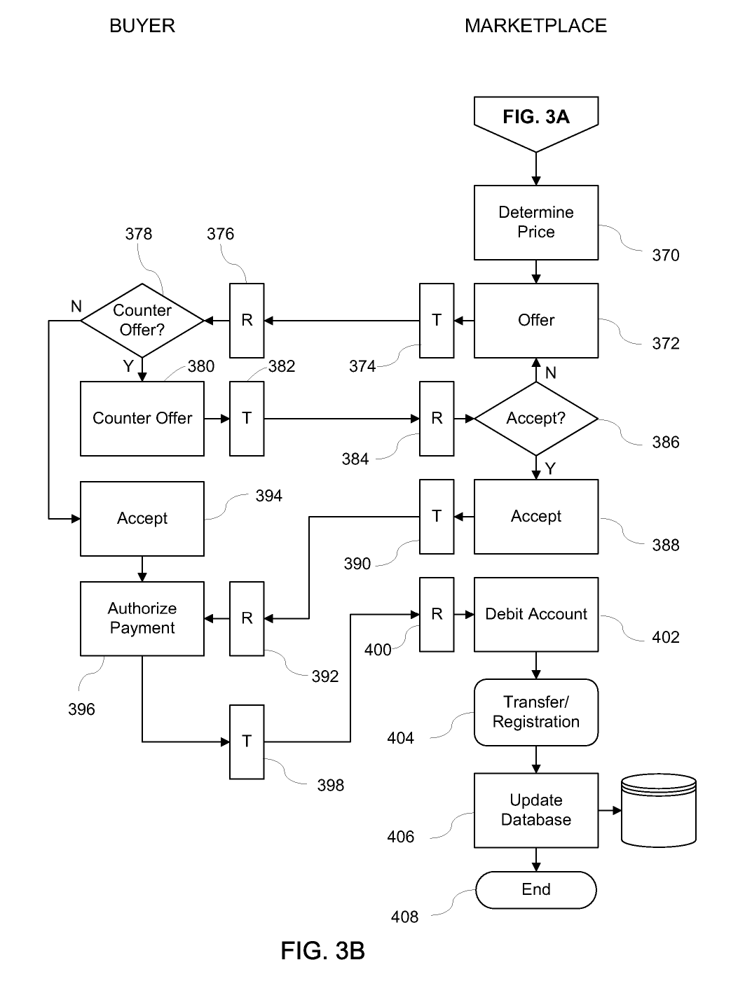

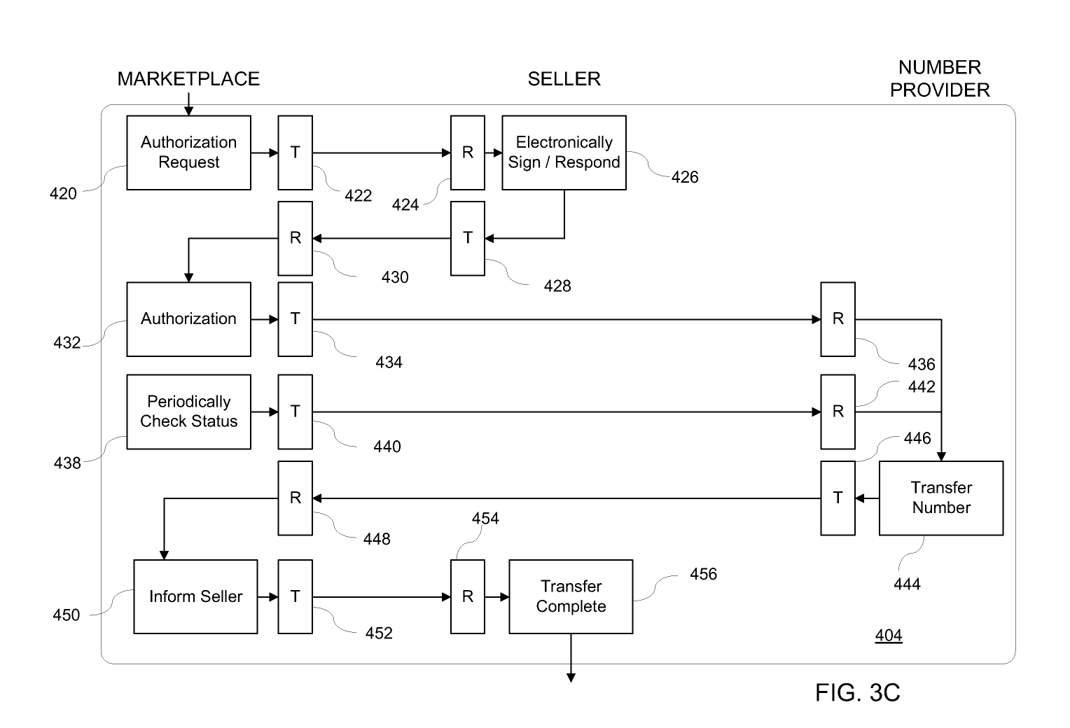

The memory 206 preferably includes high-speed random access memory and may include non-volatile memory, such as one or more magnetic disk storage devices. The memory 206 preferably stores an operating system 220, such as LINUX, UNIX or WINDOWS that includes procedures for handling basic system services and for performing hardware-dependent tasks. The memory 206 also preferably stores communication procedures 222 used for communicating with the network 118, buyer clients 102, 104 and 106, seller clients 110, 112 and 114, and the number provider server 108 (all of FIG. 1). In particular, the communication procedures 222 are used for receiving requests for telephone numbers from the buyers, selling telephone numbers from sellers, and supplying telephone numbers to the buyers, as described below in relation to FIGS. 3A-3C.

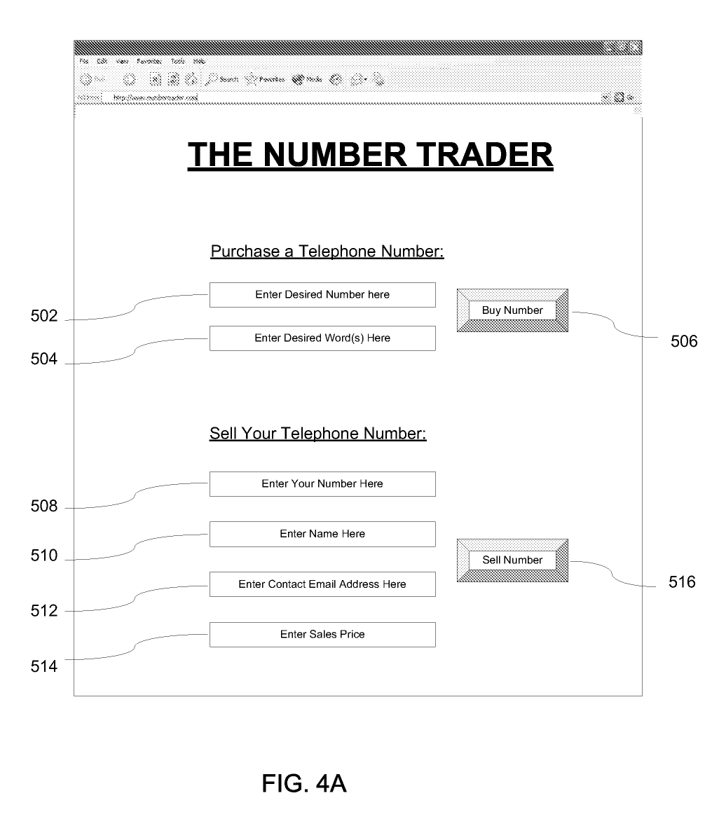

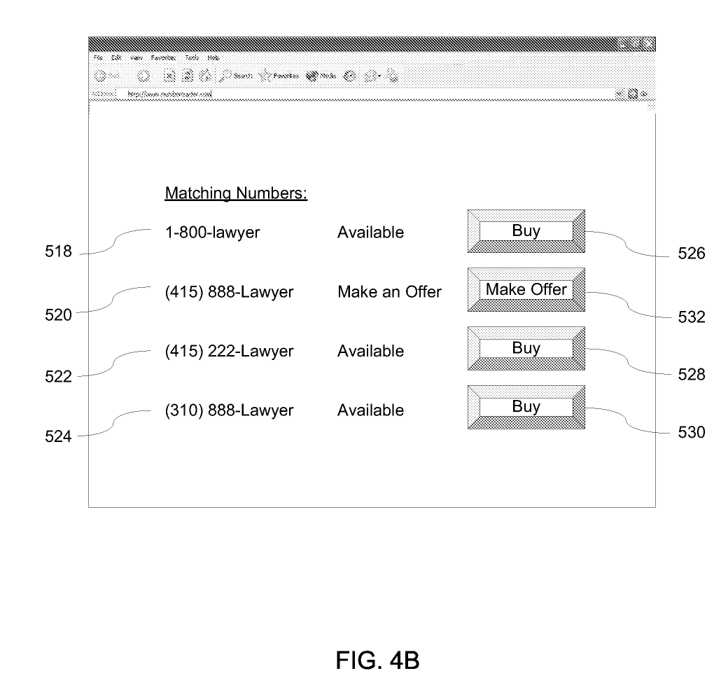

The memory 206 also preferably includes: search procedures 224 for searching a database of telephone numbers; authentication and login procedures 226 for authenticating users of the system and logging them into the system; auction procedures 227 for auctioning telephone numbers; electronic commerce (eCommerce) procedures 228 for electronically facilitating financial transactions; string to number procedures 230 for converting a string of text into a telephone number; telephone number registration and transfer procedures 232 for facilitating the transfer of telephone numbers and the registration of telephone numbers in buyers' names; a database 234 of telephone numbers; and a cache 238 for temporarily storing data. The database 234 contains separate entries for each telephone number on file. The telephone numbers listed in the database 234 may be telephone numbers that the marketplace operator has for sale or telephone numbers that sellers have listed for sale. Each telephone number entry 236(1)-(N) in the database 234 preferably includes one or more strings of characters that correspond to the particular entry's telephone number. Each telephone number entry 236(1)-(N) also preferably includes details of the for the owner of the particular telephone number, be it the marketplace operator, a seller or a telephone service provider. By owner it is meant the registered user of the telephone number, or the subscriber to whom the telephone number has been assigned. A more detailed description of the various procedures are described below with reference to FIGS. 4 and 5.

FIGS. 3A through 3C are flow charts of a method for buying, selling or trading telephone numbers (including auctioning). Initially, at step 300, a seller logs-into the system using a network access software application, such as an Internet Browser, on one of the seller client computers 110, 112 or 114 (FIG. 1). Logging-into the marketplace server 116 (FIG. 1) preferably occurs only after a seller has registered with the telephone number marketplace service and supplied owner details, authentication data, etc. Log-in is preferably processed by the authentication and login procedures 226 (FIG. 2). The seller then offers his or her telephone number for sale, at step 302, by entering offer data, such as the telephone number for sale, the sales price of the telephone number, the user's contact details, etc. For example, looking at the screenshot shown in FIG. 4A, the seller may offer his telephone number for sale by entering the telephone number into field 508, entering the seller's name into field 510, entering the seller's preferred contact email address into field 512, entering the sales price into field 514, and selecting the “Sell Number” button 516 to transmit the sales information to the marketplace server 116 (FIG. 1).

The sales details are then transmitted to the marketplace server 116 (FIG. 1) at step 304, which receives the telephone number offered for sale or trade by the seller, at step 306. The authentication and login procedures 226 (FIG. 2) on the marketplace server 116 (FIG. 1) then preferably verify that the telephone number offered for sale by the seller is a) a legitimate telephone number, and b) belongs to the seller, at step 308. This verification may be performed by any suitable means, such as: performing a reverse lookup of the telephone number in an online telephone number directory and comparing the true owner's details to those of the seller; performing the same verification and comparison using the number provider server 108 (FIG. 1); automatically calling the seller at the telephone number offered for sale and requesting a keyed response; or the like. If the telephone number is verified (308—Yes) then the telephone number and associated seller details are stored in a new entry 236(1)-(N) (FIG. 2) in the database 234 (FIG. 2), at step 310. This telephone number may then be purchased anytime later by a buyer, as described below.

A buyer also using a network access software application, such as an Internet Browser, on one of the buyer client computers, 102, 104 or 106 (FIG. 1) may initiate a telephone number transaction at any time by logging-in to the marketplace server 116 (FIG. 1) at step 312. As described above, such logging-in to the marketplace server 116 (FIG. 1) typically occurs only after the buyer has registered with the telephone number marketplace service by supplying his or her details, authentication data, etc. The authentication and login procedures 226 (FIG. 2) on the marketplace server 116 (FIG. 1) handle all registration of new users of the system and all subsequent security, such as logging-in, etc.

The buyer may then input a string of characters (such at word), for which he/she would like to find a corresponding telephone number at step 314. For example, looking at the screenshot shown in FIG. 4A, the buyer may enter a desired word into the field 504 (FIG. 4A), such as “lawyer,” and select the “Buy Number” button 506 (FIG. 4A). This will initiate a search for all telephone numbers that contain the sequence of numbers that correspond to “lawyer,” i.e., “529937.” Alternatively, the buyer may input a desired telephone number at step 328. For example, looking at the screenshot shown in FIG. 4A, the buyer may enter a desired telephone number into field 502 (FIG. 4A), such as “888-2345” and select the “Buy Number” button 506 (FIG. 4A) to transmit the telephone number request to the marketplace server 116 (FIG. 1).

If the seller input a string of characters and not a telephone number at step 314, the string is transmitted to the marketplace server 116 (FIG. 1), at step 316, which receives it at step 318. The search procedures 224 (FIG. 2) on the marketplace server then search the database 234 (FIG. 2), at step 320, for telephone numbers that correspond to the string received at step 318. For example, all telephone numbers containing the numbers “52993” that correspond to “lawyer” are searched. In a preferred embodiment, the search procedures use the buyer's contact details to narrow the search to those area codes near which the buyer resides. One or more numbers are then located at step 320. Bear in mind that one or more telephone numbers are always located, as each numeral 2 through 9 corresponds to one of the letters of the alphabet.

The located telephone number(s) are then transmitted back to the buyer client at step 322. These telephone numbers are received by the buyer client at step 324 and subsequently displayed to the buyer at step 326. For example, FIG. 4B shown a list of telephone numbers 518 to 524 (FIG. 4B)that were located for a search string of “lawyer.” As can be seen from FIG. 4B, some numbers may be available to purchase from the marketplace 518, 522, and 524, while others 520 (FIG. 4B) are not available and the buyer may make an offer to a potential seller to buy the telephone number, as described below. If the buyer wants to buy an available number he/she selects the “Buy” button 526, 528 or 530 (FIG. 4B). If the buyer wants to make an offer for a seller's telephone number, he/she selects the “Make Offer” button 532 (FIG. 4B), as further described below.

Returning to FIG. 3A, at step 328, the buyer may select one of the telephone numbers to purchase (or make an offer for) by selecting a number displayed at step 326. Alternatively, the buyer may enter a desired number, as described above. The desired telephone number is then transmitted to the marketplace server, at step 330, and subsequently received by the marketplace server at step 332. The search procedures then search for the desired telephone number at step 334.

The search procedures then determine whether the desired telephone number was located in the database 234 (FIG. 2) at step 336. If the telephone number was located in the database (336—Yes), then the process continues as described in relation to FIG. 3B below. If the telephone number was not located in the database (336—No), then the search procedures determine whether the telephone number exists at all, i.e., whether the telephone number is a legitimate or real telephone number, at step 338. This may be accomplished by performing a reverse look-up using of the telephone number in an online telephone directory or in the number provider server 108 (FIG. 1), or the system may attempt to call the number to verify that the number exists.

If the telephone number does not exist (338—No), then a message is transmitted to the buyer, at step 340, informing the buyer that the desired telephone number does not exist. The message is received by the buyer computer, at step 342, and displayed to the buyer at step 344. The buyer is again presented with a user interface to try another telephone number at step 328. If the telephone number does exist (338—Yes), then a message is generated asking the buyer if he or she would like to make an offer for the number, even though it is not currently being offered for sale by the telephone number marketplace service, at step 346. This message is transmitted to the buyer computer, at step 348, and is received at step 350. If the buyer does not want to make an offer for the telephone number (352—No), then the buyer is again presented with a user interface to try another telephone number at step 328. However, if the buyer does want to make an offer for the telephone number (352—Yes), then an offer generated by the buyer, at step 354, and transmitted to the marketplace server at step 356. The buyer may also be notified, at step 354, to recheck the system for the availability of the number after a the passage of a predetermined period of time, such as one week. Alternatively, the marketplace server can contact the buyer, such as by electronic mail, if or when the number is made available for sale by the telephone number's owner.

The marketplace server receives the offer, at step 358, and formulates a request to the owner of the desired telephone number at step 360. The request may be: a text message (or short message service (SMS) message) that will be transmitted to desired telephone number, if the desired telephone number is a cellular telephone number; an electronic mail (or regular mail) message communicated to the owner, where the owner's email is located by performing a reverse look-up of the telephone number; an automated audio message that will be played to the party answering the telephone at the desired telephone number; or a live operator can make a call to the desired telephone number. In some embodiments, the request, containing the offer, is transmitted to the seller at step 362. The request is received by the seller at step 364. If the seller is interested in selling his or her telephone number (366—Yes), then the seller can either accept the offer made by the buyer or generate a counter offer at step 368. In a preferred embodiment, the offer is then formulated and entered into fields 508 to 514 (FIG. 4A), as described above, at step 302, for onward transmittal to the marketplace server.

Looking at FIG. 3B, if the telephone number is located in the database (336—Yes), then the ecommerce procedures 228 (FIG. 2) determine the market price for the located telephone number at step 370. The ecommerce procedures then generate an offer, at step 372, which is transmitted to the buyer at step 374. The buyer receives the offer at step 376. If the buyer is not satisfied with the offer (378—Yes), the buyer may make a counter-offer at step 380. The counter offer is transmitted to the marketplace server at step 382, which receives it at step 384. The ecommerce procedures then determine whether or not to accept the counter offer at step 386. If the counter offer is not accepted (386—No), the offer is again formulated and transmitted to the seller at steps 372 and 374, respectively. If the counter offer is accepted (366—Yes), then the ecommerce procedures accept the counter offer, at step 388, by generating an acceptance message that is transmitted to the buyer at step 390. The acceptance is subsequently received by the buyer at step 372.

If no counter-offer is made (378—No), or if the counter offer is accepted (386—Yes), then the buyer is requested to authorize payment for the telephone number. The acceptance may be undertaken by communicating the counter offer to the seller as described above in relation to steps 360 to 368, or the seller may have on file with the marketplace server a minimum price that he or she is willing to accept for the telephone number.

The buyer may then authorize a payment, at step 396, which is transmitted to the marketplace server at step 398. In a preferred embodiment, at the time of registering with the marketplace system, buyers and sellers are requested to provide financial details, such as a credit card number, bank account, or PAYPAL account. The authorization is then received at step 400 and the buyers account debited at step 402 by the eCommerce procedures 228 (FIG. 2). Once the buyers account has been debited at step 402, the transfer of the telephone number takes place, at step 404, as described in further detail below in relation to FIG. 3C.

FIG. 3C is a flow chart showing the telephone number transfer step 404 of FIG. 3C. The registration and transfer procedures 234 (FIG. 2) generate an authorization request, at step 420, which is transferred to the seller at step 422. The seller receives the authorization request, at step 424, and either electronically signs the request, responds to the request, or prints, signs and faxes back the authorization to transfer the telephone number at step 426. The authorization to transfer the telephone number is then transmitted to the marketplace server at step 428, which receives the authorization at step 430. The registration and transfer procedures 232 (FIG. 2) then generate an authorization, at step 432, which is transmitted to the number provider server 108 (FIG. 1) at step 434. The number provider server receives the authorization to transfer at step 436.

Periodically, such as once a day, the marketplace server will check the status of the transfer by generating a status check, at step 438, which is transmitted to the number provider at step 440. The number provider server receives the status check at step 442. Once the number has been transferred, at step 444, a notification of the transfer is transmitted to the marketplace server at step 446. This notification is received by the marketplace server, at step 448, which then formulates a notification to the seller that the transfer has been completed at step 450. This may take the form of an email that is transmitted to the seller at step 452. The notification is received by the seller at step 454 and the transfer completed at step 456.

Returning to FIG. 3C, the transfer of the number may also require registration of the new number in the name of the buyer. The database 234 (FIG. 2) is then updated with the new details of the transaction at step 406, and the process ends at step 408.

The foregoing descriptions of specific embodiments of the present invention are presented for purposes of illustration and description. For example, any methods described herein are merely examples intended to illustrate one way of performing the invention. They are not intended to be exhaustive or to limit the invention to the precise forms disclosed. Obviously many modifications and variations are possible in view of the above teachings. Also, any Figures described herein are not drawn to scale. Furthermore, the order of steps in the method are not necessarily intended to occur in the sequence laid out. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What we claim is:

1. A computer implemented method for facilitating the sale of a telephone number from a seller to a buyer over a network, comprising:
receiving at a server a request from a buyer to buy a telephone number from a seller;
facilitating a sale of said telephone number from said seller to said buyer; and
effecting transfer of said telephone number to said buyer.

2. The computer implemented method of claim 1, wherein said facilitating comprises:
searching a database of multiple telephone numbers for said telephone number;
locating said telephone number; and
contracting with said buyer to purchase said telephone number.

3. The computer implemented method of claim 2, wherein said contracting comprises:
offering for sale said telephone number to said buyer;
receiving an acceptance of said offering for sale from said buyer; and
obtaining compensation for said telephone number from said buyer.

4. The computer implemented method of claim 3, wherein said obtaining comprises debiting an account of said buyer.

5. The computer implemented method of claim 1, further comprising, before said receiving:
receiving at the server an offer for sale of a telephone number from a seller; and
storing said offer for sale in a database, where said offer for sale includes the telephone number for sale and details about said seller.

6. The computer implemented method of claim 1, further comprising, before said receiving:
receiving from a buyer a search request containing a string of characters;
searching a database of telephone numbers for one or more telephone numbers that correspond to said string of characters;
locating at least one telephone number that corresponds to said string of characters; and
transmitting said at least one telephone number to said buyer.

7. The computer implemented method of claim 6, wherein said string of numbers corresponds to a word, a term, a phrase, letters, numbers and letters, or any combination of the aforementioned.

8. The computer implemented method of claim 1, wherein said effecting further comprises:
receiving from said seller an authorization to transfer said telephone number from said seller to said buyer; and
requesting transfer of said desired telephone number from said seller to said buyer.

9. The computer implemented method of claim 8, further comprising:
receiving an acknowledgement that said transfer of said telephone number from said seller to said buyer has been effected;
informing said buyer of said transfer; and
updating said database to reflect that the telephone number is now owned by said buyer.

10. The computer implemented method of claim 1, further comprising offering to purchase said telephone number from said seller, if said desired telephone number is not for sale.

11. The computer implemented method of claim 10, wherein said offering comprises transmitting an offer to purchase said telephone number to said seller.

12. The computer implemented method of claim 10, further comprising, before said offering, performing a reverse look-up of said telephone number to determine details of said seller.

13. A computer implemented method for facilitating the sale of telephone numbers, comprising:
receiving at a server an offer for sale of a telephone number from a seller;
storing said offer for sale in a database, where said offer for sale includes the telephone number for sale and details about said seller;
receiving at a server a request from a buyer to buy a desired telephone number;
searching said database for said desired telephone number;
facilitating a sale of said desired telephone number from said seller to said buyer; and
requesting transfer of said desired telephone number from said seller to said buyer.

14. A computer implemented method of claim 13, wherein said facilitating comprises:
searching a database of multiple telephone numbers for said telephone number;
locating said telephone number; and
contracting with said buyer to purchase said telephone number.

15. The computer implemented method of claim 13, wherein said facilitating comprises:
offering for sale said telephone number to said buyer;
receiving an acceptance from said buyer; and
obtaining payment for said telephone number from said buyer.

16. The computer implemented method of claim 13, further comprising, before said receiving:
receiving from a buyer a search request containing a string of characters;
searching a database of telephone numbers for one or more telephone numbers that correspond to said string of characters;
locating at least one telephone number that corresponds to said string of characters; and
transmitting said at least one telephone number to said buyer.

17. The computer implemented method of claim 16, wherein said string of numbers is selected from the group consisting of: at least one word, letters, numbers and letters, and any combination of the aforementioned.

18. The computer implemented method of claim 13, wherein said sale of said desired telephone number from said seller to said buyer is an auction.

19. A system for facilitating the sale of telephone numbers, comprising:
a network;
at least one buyer client computer operated by a buyer, where said buyer client computer is coupled to said network;
at least one seller client computer operated by a seller, where said seller client computer is coupled to said network;
a server coupled to said network, where said server comprises:
a bus;
a processor coupled to said bus;
communication circuitry coupled to said bus, where said communication circuitry is configured for communicating with said network, buyer client computer and seller client computer; and
a memory coupled to the bus, said memory comprising:
an operating system;
communication procedures for receiving an offer for sale of a telephone number from the seller, and for receiving a request from a buyer to buy a desired telephone number;
a database containing multiple telephone numbers for sale and seller details for each of said multiple telephone numbers;
search procedures for searching said database for said desired telephone number;
instructions for facilitating a sale of said desired telephone number from said seller to said buyer; and
instructions for transferring said desired telephone number from said seller to said buyer.

20. A computer program product for facilitating the sale of telephone numbers, the computer program product comprising computer readable storage and a computer program stored therein, the computer program comprising:
instructions for receiving at a server an offer for sale of a telephone number from a seller;
instructions for storing said offer for sale in a database, where said offer for sale includes the telephone number for sale and details about said seller;
instructions for receiving at a server a request from a buyer to buy a desired telephone number;
instructions for searching said database for said desired telephone number;
instructions for facilitating a sale of said desired telephone number from said seller to said buyer; and
instructions for requesting transfer of said desired telephone number from said seller to said buyer.
